(19) United States
(12) Patent Application Publication
(10) Pub. No.: US 2007/0122595 A1
(43) Pub. Date: May 31, 2007

(54) Absorbent paper sheet

(75) Inventors: Michel Basler, Issenheim (FR); Benoit Hoeft, Bischwihr (FR); Sebastien Jeannot, Bischwihr (FR)

Correspondence Address: PATENT GROUP GA030-43;GEORGIA-PACIFIC LLC, 133 PEACHTREE STREET, N.E., ATLANTA, GA, 30303-1847, US

(73) Assignee: Georgia-Pacific France, Kunheim (FR)

(21) Appl. No.: 10/574,325

(22) PCT Filed: Oct. 1, 2004
(86) PCT No.: PCT/FR04/02493

§ 371 Date: Apr. 3, 2006

(30) Foreign Application Priority Data
Oct. 2, 2003 (EP) 0311558
Mar. 26, 2004 (EP) 04290811.1

(51) Int. Cl. B32B 1/00

(52) U.S. Cl. 428/174; 428/172

(57) ABSTRACT

This invention relates to a sheet comprising at least a first ply P₁ and a second ply P₂ superimposed on one another and made of absorbent paper, such as tissue paper, each ply having a grammage of between 10 and 40 g/m², the first ply presenting on its outer side cavities formed by embossing, corresponding to protuberances on its other side adjacent to the second ply. The sheet is characterized in that the first ply P1 comprises first zones A₁ forming cells with first cavities (12), the cells being surrounded by second zones A₂ with second cavities (18), the first zones A₁ being in relief on the outer side in relation to the second zones A₂ with a level difference N_{A}, the first zones A₁ presenting a contour D with a marking line. The invention also relates to the embossing device permitting such a sheet product to be obtained. The product of the invention is applicable to the manufacture of paper for sanitary or household use.

This invention relates to the field of products for sanitary or household use made with sheets of absorbent paper, such as tissue paper.

In particular, the invention relates to a sheet comprising at least one embossed ply for use essentially as toilet paper but also as a handkerchief, a table napkin or optionally an all-purpose paper towel. In the sanitary or household paper industry, products of this type are manufactured with an absorbent paper, generally creped, with a low basis weight or grammage, namely tissue paper, also called cotton tissue. The elongation capacity conferred by the creping process allows the sheet to be embossed. This operation consists in permanently deforming the sheet between a rigid featuring elements in relief or “picots” on its surface, and a mating cylinder for example one with a resilient coating. Thus, the apparent thickness of the sheet is increased by the protuberances on one side. Cavities on the other side correspond to these protuberances.

The trend in recent years has been to make tissue paper products softer and plusher by enhancing their thickness and strength characteristics through this embossing process. This embossing also makes it possible to improve the visual appeal of the product through a judicious selection of the embossing pattern. Under this invention, the embossing process is carried out on paper with a low rate of humidity during a paper sheet transformation stage downstream of the paper machine.

Most often the embossing patterns consist of a series of elementary protuberances having a small transverse section and a simple geometric shape. One example is described in U.S. Pat. No. 3,414,459, which pertains to a sheet consisting of a plurality of superimposed plies that are glued together. The plies have been embossed with a distribution frequency and height of protuberances suitable for the manufacture of water-absorbing products, for example, all-purpose paper towels. The number of protruding elements ranges from 5 to 30 per cm².

The applicant has developed, especially for toilet paper, patterns with a larger number of protruding elements, ranging from 30 to 80 or more per cm². These latter elements necessarily have an elementary surface with a very low top. Said surface is less than 1 mm². For these latter embodiments, an appearance is obtained that is similar to that of a woven product. An example thereof is disclosed in EP Patent 0 426 548 held by the applicant. This type of fine and dense embossing is well suited for inducing a thickness effect on the sheet.

Nevertheless, this type of embossing has limited visual appeal. Furthermore, the softness to the touch is not optimal.

The solution offered in EP 797 705 consists in producing a combined pattern comprising a graphic pattern and a background pattern. The graphic pattern is made up of protuberances that are linear in shape. Said protuberances are elongated, curvilinear, with a width of between 0.1 and 2 mm. The background pattern consists of small protuberances that are generally tapered and distributed at a ratio of at least 30 per cm². This solution permits a wide choice of patterns while also offering a good compromise between sheet softness and sheet thickness.

This invention relates to a sheet comprising at least two superimposed plies of absorbent paper, such as tissue paper, with a grammage of between 10 and 40 g/m², of which at least one has been embossed in such a way as to present on its outer side cavities corresponding to protuberances on its other side adjacent to the second ply.

The object of the invention is such a product combining thickness and softness to the touch.

According to the invention the sheet is characterized by the fact that the first ply has first zones forming cells with first cavities, the cells being surrounded by second zones with second cavities, the first zones being in relief on said outer side in relation to the second zones with a difference in level, the first zones presenting a contour with a marking line.

The solution of the invention, by virtue of the effect produced by the pads formed by the first zones, gives the product an impression of remarkable thickness. Furthermore, due to the cavities of the first zones, this impression of thickness is confirmed upon touching. Indeed, the protuberances corresponding to the cavities give the surface of the first zones a structure such as to offer a resistance to crushing. This crush resistance confers volume to the sheet. Also, the presence of the second cavities reinforces the relief effect, in particular when these cavities are at least in part aligned with the contour of the first zones. Finally, the marking permits reinforcing both the visual effect conveyed by the zones in relief and their crush resistance.

According to another characteristic, the height of the first protuberances is at the most equal to the height of the second protuberances, plus the difference in level between the first zones and the second zones. Preferably, the height is lower; in this way a collapsing of the first zones in relief is avoided.

According to another characteristic, the product has non-embossed third zones between the various second zones that enhance through contrast the impression of thickness.

Nevertheless, without departing from the spirit or scope of the invention, the third zones (between the various second zones) may also be embossed.

According to another characteristic, the first protuberances are tapered and at least part of the first zones features third protuberances of a linear shape.

According to one embodiment, the second ply superimposed on the first ply is not embossed.

According to another embodiment, the second ply is embossed. It may present protuberances arranged in such a way that the two plies are in contact through the tops of the second protuberances. They may preferably be bound through at least one glue application on the top of the second protuberances and/or on the top of the third cavities. In particular, the first protuberances are not glued. By way of a non-limitative example, the joining mode may be of the top-to-top type or of the nested protuberance type or the second ply may be uniformly embossed.

This invention also relates to a device for the manufacture of a sheet of paper. It comprises at least one cylinder with a rigid covering suitably engraved so as to present first zones forming cells surrounded by second zones, the first zones featuring first picots and the second zones featuring second picots, the bottom of the engraving of the first zones being at a level that, as measured in relation to the axis of the cylinder, is below that of the second zones.

According to one special embodiment, the top of the first picots is at a level below that of the tops of the second picots.

According to another particularly advantageous characteristic, the transition surface between the first zones and the second zones consist, at least in part, of elements with a tapered surface defining a gripping edge. This arrangement permits marking the contour of the first zones which stand out by contrasting with the second and third zones. According to a preferred embodiment, the contour forms a closed perimeter.

Below one embodiment of the invention is described with reference to the drawings in which:

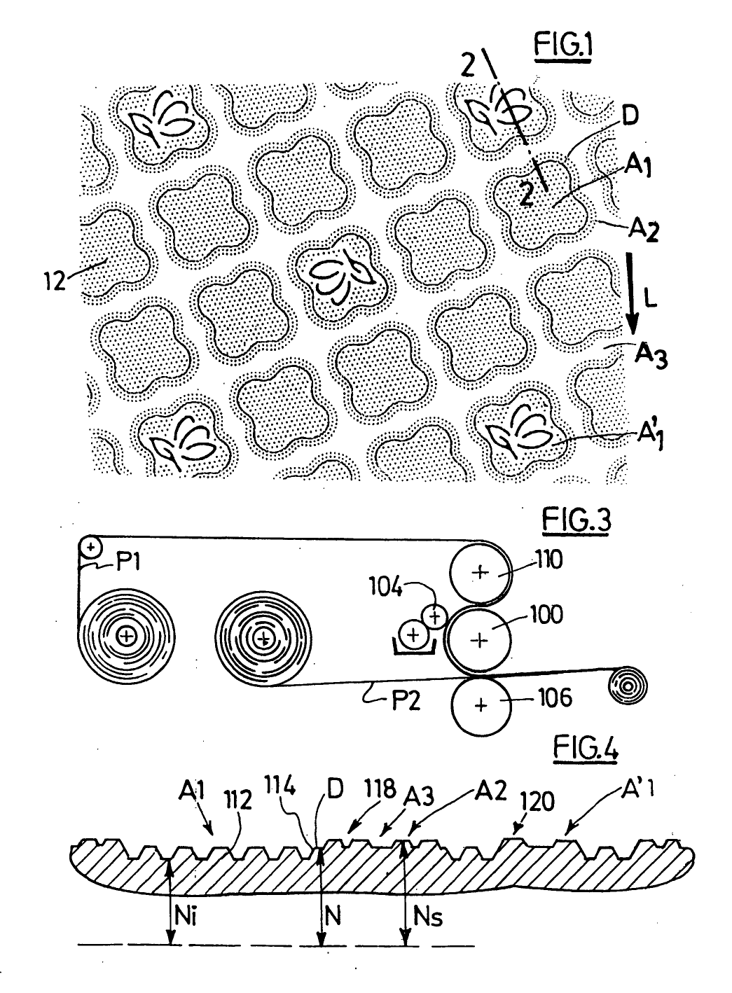

FIG. 1 shows a top view of a sheet embossed in accordance with one embodiment of the invention.

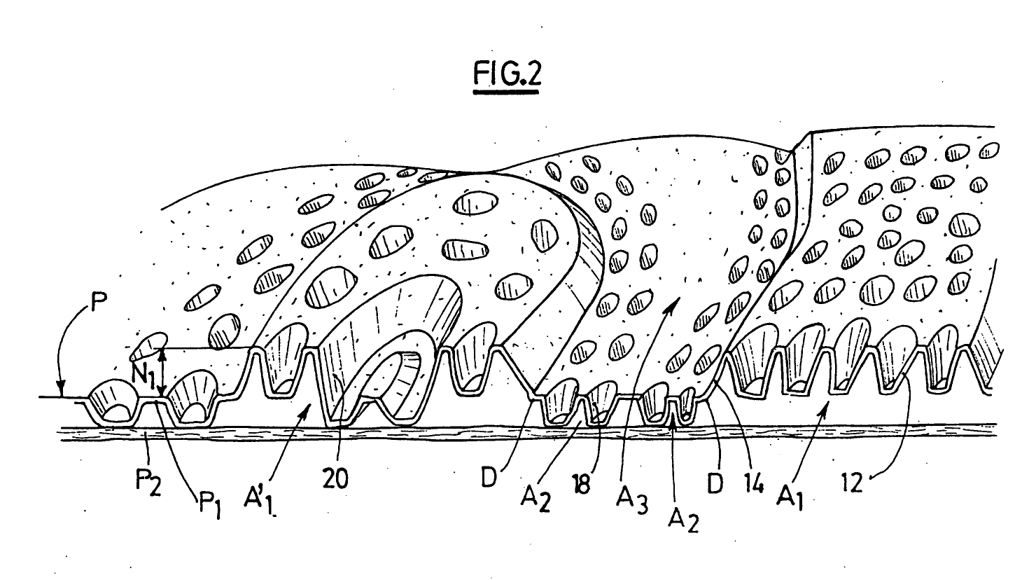

FIG. 2 shows a perspective view, in partial cross section of the sheet along line II II of FIG. 1.

FIG. 3 is a view of an embossing machine permitting the manufacture of the product claimed by the invention;

FIG. 4 is a detail drawing of a cylinder engraved according to the pattern of the invention;

FIG. 5 is a cross-section of a sheet according to another embodiment of the invention;

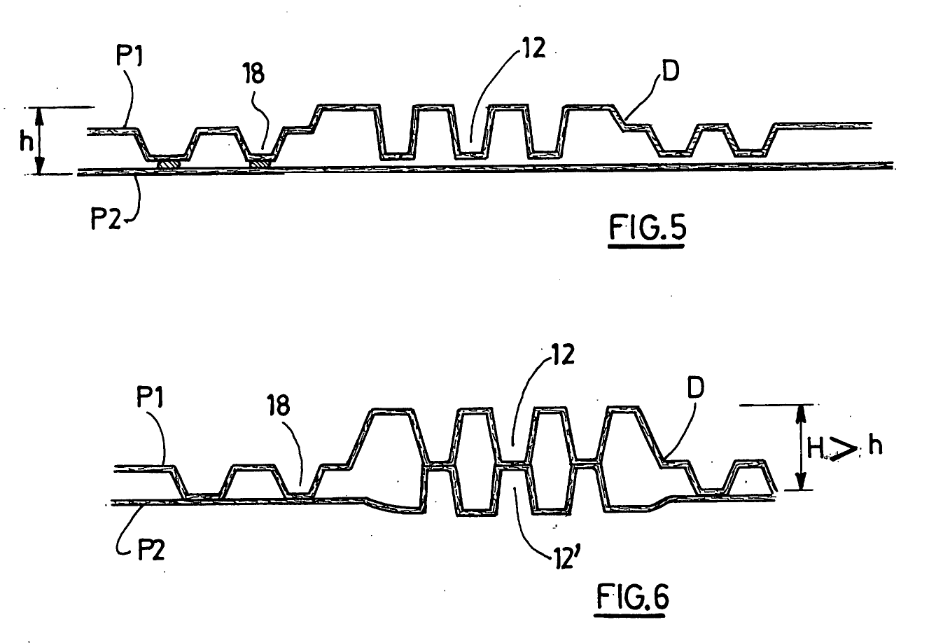

FIG. 6 is a cross-section of a sheet according to yet another embodiment of the invention;

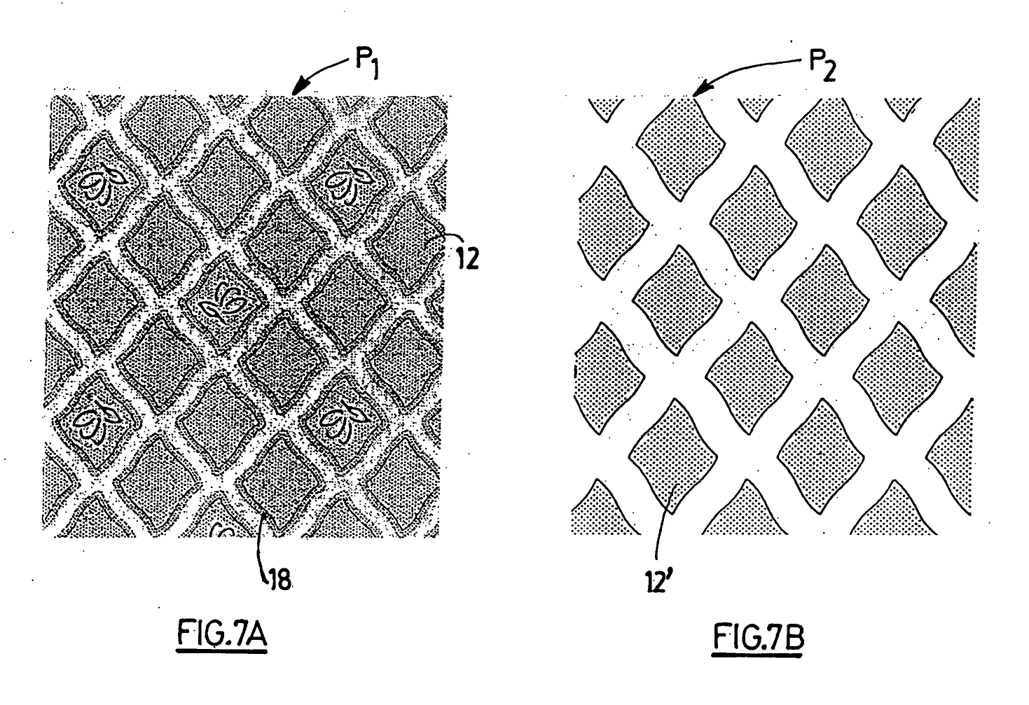

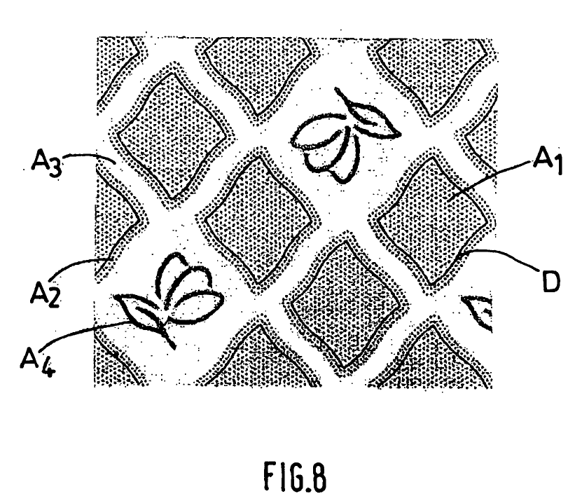

FIGS. 7A and 7B represent respectively the front and back of a sheet according to an embodiment in keeping with that of FIG. 6; and

FIG. 8 illustrates an embossing that is characteristic of an additional embodiment.

The sheet represented in FIGS. 1 and 2 is a sheet comprising two plies P1 and P2 of absorbent paper, for example of creped tissue paper. The grammage of the paper is preferably between 10 and 40 g/m². The sheet comprises an embossed first ply P1, called the upper ply, and a second ply P2, called the lower ply. According to this example, the second ply is not embossed. The upper ply is for example of the type obtained according to a conventional wet pressing process that in the industry is traditionally called CWP or it is of a paper obtained according to a process involving the through-air drying of the sheet called TAD in the industry. The lower ply may be either a CWP or a TAD paper.

One paper-manufacturing process, of the CWP type, consists in depositing the paper fibers in suspension in water onto a cloth in order to form a sheet. The sheet is drained and then transferred onto a piece of felt that will make it possible to apply it with a press against a drying cylinder. The sheet is pulled there from and is creped by means of a blade used as a scraper. It is then finally reeled while awaiting processing into the finished product. Such a technique as briefly summarized here is called conventional.

One technique of the TAD type consists, after draining, in drying the sheet without exerting any pressure, in part at least, until achieving a sufficient dryness for freezing the fibers within the sheet. If applicable, the drying is completed by application of the sheet onto a heated cylinder. Thanks to that first drying, the sheet can be pressed onto a heated cylinder; it maintains part of its volume. This cylinder also permits its creping. The drying is accomplished without pressure by blowing hot air through the sheet after draining. This TAD technique permits the obtaining of thicker sheets having a higher specific volume than does the conventional technique.

With reference to FIG. 1, one sees a combination of dots and lines. The dots represent cavities or protuberances depending on which side of the ply is observed. The lines also represent cavities or protuberances depending on the side observed. Their form is elongated. Certain lines represent simple markings as will be seen further on. The cavities/protuberances are obtained by deforming the sheet between a rigid-surface tool, such as an engraved cylinder made of steel, and a mating cylinder made of rubber for example. The rigid surface of the cylinder presents relief elements arranged according to the pattern that is wished to be obtained on the tissue-paper sheet. These picots have an essentially trapezoidal profile in the direction of the height. If they are tapered their cross-section, in relation to their axis, is circular, oval or polygonal.

In FIG. 1, considering that it shows the outer side of the sheet, we see the cavities 12 distributed inside the first zones A₁. The zones A₁ are themselves evenly distributed here throughout the surface of the sheet according to a constant-pitch pattern in two directions that are perpendicular to each other. One of the directions is slightly inclined in relation to the machine direction represented by direction L and which corresponds to the movement direction of the sheet during its manufacture. Each zone A₁ is delimited by a continuous line D obtained by marking of the sheet, as shall be explained further on.

Outside of the marking line D, each zone A₁ is surrounded with a second zone A₂ consisting of cavities aligned parallel to the marking line D. Between the various second zones A₂, third non-embossed zones A₃ are discerned.

Certain first zones, called as A′₁, comprise first cavities 12 and also third cavities 20 such as those visible in FIG. 2.

With reference to FIG. 2, the various zones are represented in a cross-section and in greater detail. The sheet is viewed partially from above with upper ply P₁ superimposed on lower ply P₂. The embossing on ply P₁ defines several zones A₁, A₂, and A₃. The first zones A₁ are in relief in relation to zones A₂ and A₃. These first zones A₁ comprise first protuberances 12 having an overall tapered shape and protruding inside the sheet. Each protuberance forms a cavity on the outer side of ply P₁. In the zones A₁, the protuberances have a height that is at the most equal to the distance separating the outer side of the ply P₁ from P₂. According to the embodiment in the FIGURE, the height is lower. It corresponds essentially to the height of zone A₁ in relation to the reference plane formed by zones A₂ and A₃. Zone A₁ comprises between 30 and 100 protuberances per cm², preferably between 30 and 60. Due to this high number of protuberances per surface unit, the dimensions of these protuberances are necessarily limited. The overall height of these protuberances is between 0.3 mm and 1 mm. The diameter of the flat surface at the top is here is on the order of 0.4 mm.

The zones A₁ are delimited by an inclined wall 14 whose lower edge forms a separation line D with the adjacent zone A₂. This line is clearly visible because it is obtained by marking of the sheet. Ply P₁ forms preferably an inside edge along this line D. On the edge, outside of zones A₁ and along this line D, there are found second protuberances 18 arranged protruding, also inside the sheet, toward ply P₂. These protuberances are here aligned in two parallel rows along line D. The second protuberances may be of the same dimensions as the first ones. They are in contact with the lower ply P₂ through their top. They provide the bonding with said top through in particular an adhesive film. Other means of bonding between the two plies are possible, such as for example by knurling.

Without departing from the scope of the invention, any mechanical bonding may be considered.

One observes that the second protuberances 18 do not occupy the entire surface between the adjacent zones A₁. Thus, third zones A₃ that are not embossed are delimited. The plane of these zones A₂ and A₃ constitutes plane P called the reference plane. The first zones A₁ are in relief in relation to this reference plane with a level difference N_{A}.

Variants of zones A₁ are also discerned. These are the first zones A′₁. They may comprise third protuberances whose shape is not tapered. They have a linear shape because their top has an elongated form like a line. In the embodiment of FIG. 1, they represent the flower design. Advantageously, these third projections 20 have a height sufficient to come into contact with ply P₂. In order to stabilize the volume, the two plies are also bonded through their top.

In order to manufacture the sheet described above, a machine such as the one represented in FIG. 3 is preferably used. This machine comprises a first rotating cylinder 100, made of steel or of other rigid material, suitably engraved on the surface according to the pattern that permits achieving the embossing whose pattern is represented in FIG. 1. A cylinder made of rubber 110 is mounted rotatably on an axis parallel to the first one. It rests on the cylinder by the means of appropriate jacks not shown. A first paper band is guided, from a downstream reel, around cylinder 110 then between the two cylinders 100 and 110. The sheet then takes on the shape of the relief of cylinder 100 due to the pressure of the rubber. Depending on the pressure of the jacks and the nature of the rubber, the paper penetrates more or less deeply inside the engraved pattern. The fineness of the pattern is also a parameter to be taken into account. The sheet plied together on cylinder 100 then passes in front of a gluing machine 104 that applies glue on the top of the relief elements. The gluing machine is here a rigid-surface cylinder that receives the glue from a scraping chamber for example.

A second paper band coming out of a second reel, for example, is laid against the first band by a mating cylinder 106. The glue film on the first sheet P₁ migrates in part onto those parts of second band P₂ that come into contact with the parts in relief of band P₁. The two plies are thus bonded to each other by these surfaces in contact. The two-ply sheet is then reeled for further processing.

Processes other than the latter may be applied, depending on the product that one wishes to obtain. One may replace for example roll 106 with a second embossing unit and join the plies in the top-to-top mode or in the nested mode with a mating cylinder as is well known to those skilled in the art.

Represented in FIG. 4 is a portion in cross-section of the surface of cylinder 100. It is the picture of ply P₁ shown in FIG. 2. The cylinder comprises an engraving here with three levels. The levels are defined in relation to the axis of rotation of the cylinder. A reference level N is defined for the reference surface. In the FIGURE, one discerns in relation to its level N, a lower level Ni and an upper level Ns. The upper level Ns is that of the surface forming the overall envelope of the cylinder. The Ni level is that of the surface of the bottom of the engraving of zones A1 or A′1. One observes some first picots 112 that are tapered in shape and protrude in relation to the bottom of the engraving of level Ni. In the example represented, picots 112 have a height such that their top is at the reference level N. However, it also falls under the invention to provide picots of a different height. This height may be lower and the top of the picots is then at a level lower than N. It may be higher but then the picots are at a level lower than or equal to level Ns. Picots 112 are arranged in cavities hollowed out in the cylinder defining the zones A1. These cavities are bordered by a wall 114 that cuts the reference level surface N, along the lines forming an edge D_{A}. Along this edge, the tangent to wall 114 makes an angle of between 20° and 50° in relation to the direction perpendicular to the axis of the cylinder. Preferably, the angle is between 25° and 35°.

Between the zones A1, we discern picots 118 protruding on the reference level surface N. The top of picots 118 is at level Ns. These second picots define second zones A2. The surface portions arranged between the various zones A2 are not engraved, they are at level N. They constitute the third zones A3. Also represented in the FIGURE, in cavities A′1 forming variants of first zones, are third picots 120 non-tapered in shape but whose top is elongated.

To achieve an embossing according to the invention, the dimensional parameters are as follows:

N—Ni, that is, the depth of the cavities of the engraving that correspond to the first zones A1 in relief after embossing, is between 0.1 and 1.3 mm. The embossing of the ply P1 leads to zones A1 presenting a level difference N_{A} from the reference plane.

The difference in levels Ns—Ni is between 0.2 mm and 2.0 mm.

The height of picots 112 is between 0.1 mm and Ns—Ni. Preferably, the height of the picots is between 0.5 and 0.9 with a difference in levels Ns—Ni greater than 0.5 mm.

The height of picots 120 inside zones A′1 is preferably between 0.1 mm and Ns—Ni. Preferably, it is equal to Ns—Ni in order in particular for the corresponding protuberances on the paper to form bonding zones with the adjacent ply.

When a paper sheet is placed onto the surface of the cylinder thus defined and a rubber cylinder is applied onto the sheet, said sheet takes on the shape of its relief. It is observed that due to the presence of edge D_{A} between walls 114 and the level surface N, the sheet undergoes a strong pinching. To obtain this pinching, the rubber is applied with sufficient pressure onto the engraved surface in order for it to penetrate into the cavities of zones A1. A concentration of stresses at edge level leads to a sharp marking of the sheet along this edge line. It also contributes to forming the relief of zone A1, in particular due to the shadow produced by the marking when the sheet is illuminated by inclined light. The parameters are selected in such a way that the rubber takes on the shape of the picots so as to come as close as possible to level Ni.

On FIG. 5, a sheet is shown in cross-section: ply P1 is embossed as described hereinabove while ply P2 is smooth. Such a sheet presents a maximum thickness h.

FIG. 6 shows, in cross-section, another embodiment of the invention according to which the two plies P1 and P2 each present a different embossing.

More specifically, the embossing achieved on the first ply P1 is nearly identical to that described hereinabove while the embossing of the second ply P2 is as visible on FIG. 5. The embossing of the second ply P2 and its arrangement in relation to the first ply are such that the micro-embossings present inside each cell defined by the marking line D, are arranged opposite each other, that is, in contact top-to-top with the micro-embossing corresponding to the first ply P1; in other words, the first cavities 12 are arranged opposite cavities 12′ of the second ply P2.

Furthermore, the tops of the second cavities 18 of the first ply are provided with glue and therefore serve as points of bonding with the second ply P2; at that level ply P2 is smooth.

One thus obtains a sheet whose front and back are respectively presented on FIGS. 7A and 7B, given for illustrative purposes and in no way limitatively.

According to this embodiment of the invention, one has elected to arrange the micro-embossed zones of each ply one in front of the other.

As represented on FIG. 6, an identical pitch may be provided for the micro-embossings of each of the plies. Nevertheless, without departing from the scope of the invention, the micro-embossings achieved inside each of the cells delimited by the contours D may present differing pitches.

Advantageously, the embossing cylinder of the second ply is engraved intaglio in order to achieve the above-cited arrangement.

This arrangement makes it possible to obtain a sheet whose relief is even sharper than that of the first embodiment of the invention.

Indeed, as can be seen on FIG. 6, on the right-hand side, the distance H from top to top, that is, the thickness is higher than distance h (thickness) measured on a sheet obtained according to FIG. 2 for example.

Furthermore, the fact that the two sides of such a sheet present different embossings constitutes an unexpected and pleasing aspect for the user.

According to another embodiment of the invention, as represented on FIG. 8, one of the plies may present an embossing close to that of FIG. 1; the difference consisting in the addition of cavities (or protuberances) A₄ between the second zones A₂.

Said cavities may present themselves in the form of continuous lines as it appears from FIG. 8, or possibly in the form of dot alignments.

On FIG. 8, linear patterns are featured.

Advantageously, these linear cavities (or protuberances) represent gluing points between the plies, preferably distributed uniformly on the overall embossing.

Thus the bonding between the plies is strengthened while the external appearance is improved, in particular the relief imparted to the product.

1. A sheet comprising at least a first ply P₁ and a second ply P₂ superimposed on each other and made of absorbent paper, such as tissue paper, each ply having a grammage of between 10 and 40 g/m², the first said ply presenting on its outer side cavities formed by embossing, corresponding to protuberances on its other side adjacent to the second ply, characterized in that the first ply P₁ comprises first zones A₁ forming cells with some first cavities (12), the cells being surrounded by second zones A₂ with second cavities (18), the first zones A₁ being in relief on the outer side in relation to the second zones A₂ with a level difference N_{A}, the first zones A₁ presenting a contour D formed by a marking line.

2. The sheet as claimed in claim 1 whose depth of the first cavities (12) is at the most equal to the depth of the second cavities plus the level difference N_{A}.

3. The sheet as claimed in either of claims 1 or 2 comprising non-embossed third zones A₃ between the second zones A₂.

4. The sheet as claimed in either of claims 1 or 2 comprising third embossed zones A₄ between the second zones A₂.

5. The sheet as claimed in claim 4, characterized in that the embossing of third zones A₄ comprises cavities of a linear shape and/or alignments of cavities.

6. The sheet as claimed in claim 5 whose second cavities (18) are at least in part aligned with the contour D.

7. The sheet as claimed in claim 5 whose first cavities (12) are tapered in shape.

8. The sheet as claimed in any one of claim 5 whose first zones A₁ feature third cavities (20) with a top having a linear shape.

9. The sheet according to claim 5 whose second ply P₂ is not embossed.

10. The sheet according to claim 8 whose second ply P₂ is embossed and presents protuberances, the two plies being in contact through the tops of the protuberances corresponding to the second cavities (18) and/or the tops of the third cavities (20).

11. The sheet as claimed in claim 10 whose two plies are bonded through at least one application of glue on the top of the second protuberances (18) and/or on the top of the third cavities (20).

12. The sheet as claimed in claim 11 whose first protuberances are not glued.

13. A device for the manufacture of a sheet as claimed in claim 5 comprising at least one cylinder (100) with a rigid coating suitably engraved so as to present first zones A1 forming cells surrounded by second zones A2, the first zones A1 comprising first picots (112) and the second zones A2 comprising second picots (118), the bottom of the engraving of the first zones being at a level Ni, in relation to the rotation axis of the cylinder, lower than level N of the bottom of the engraving of the second zones.

14. The device as claimed in claim 13 in which the top of the first picots (112) is at a level lower than the level Ns of the tops of the second picots (118).

15. The device as claimed in claim 14 whose transition surface between the first zones A1 and the second zones A2 consists at least partly of elements with a tapered surface (114) defining a gripping edge D_{A}.

16. The device as claimed in claim 15 in which the angle formed by the tangent of wall (114) at the level of edge D_{A} and the cylinder radius is between 20° and 50°, preferably between 25° and 35°.

17. The device as claimed in claim 16 whose level difference N—Ni is between 0.1 mm and 1.3 mm.

18. The device as claimed in claim 17 whose level difference Ns—N is between 0.1 and 0.7 mm.

19. The device as claimed in claim 18 whose level difference Ns—Ni is between 0.2 and 2.0 mm.

20. A process for manufacturing a sheet as claimed in claim 5 wherein a band of absorbent paper is embossed by means of a device as claimed in claim 13.
